(19) United States
(12) Patent Application Publication
(10) Pub. No.: US 2015/0245075 A1
(43) Pub. Date: Aug. 27, 2015

(54) METHOD AND APPARATUS FOR IMAGE ENCODING/DECODING

(71) Applicant: Electronics and Telecommunications Research Institute, Daejeon (KR)

(72) Inventors: Jin Ho Lee, Daejeon (KR); Jung Won Kang, Daejeon (KR); Ha Hyun Lee, Seoul (KR); Jin Soo Choi, Daejeon (KR); Jin Woong Kim, Daejeon (KR)

(73) Assignee: ELECTRONICS AND TELECOMMUNICATIONS RESEARCH INSTITUTE, Daejeon (KR)

(21) Appl. No.: 14/427,103

(22) PCT Filed: Sep. 27, 2013
(86) PCT No.: PCT/KR2013/008715

§ 371 Date: Mar. 10, 2015

(30) Foreign Application Priority Data
Sep. 27, 2012 (KR) 10-2012-0107658
Apr. 17, 2013 (KR) 10-2013-0042558
Sep. 27, 2013 (KR) 10-2013-0115665

(51) Int. Cl. H04N 19/90; H04N 19/124; H04N 19/91; H04N 19/44; H04N 19/51

(52) U.S. Cl. CPC H04N 19/90; H04N 19/44; H04N 19/51; H04N 19/91; H04N 19/124

(57) ABSTRACT

Disclosed are a method and an apparatus for image encoding/decoding. The image decoding method which supports a plurality of layers according to the present invention comprises the steps of: receiving a bitstream including inter-layer switching time information that indicates whether inter-layer switching from a first layer to a second layer is possible; and decoding the bitstream based on the inter-layer switching time information. The inter-layer switching time information includes information on the layer switching picture (LSP) of the time when inter-layer switching is possible. The information on the layer switching picture is induced from the network abstraction layer (NAL) unit type parsed from the bitstream.

### TECHNICAL FIELD The present invention relates to image encoding and decoding, and more particularly, to image encoding and decoding based on scalable video coding (SVC).

### BACKGROUND ART

In recent years, while a multimedia environment has been built up, various terminals and networks have been used and the resulting use requirement has been diversified.

For example, as a performance and a computing capability of a terminal have been diversified, a supported performance has also been diversified for each apparatus. Further, in the case of a network in which information is transmitted, a pattern, an information amount, and a transmission speed of the transmitted information, as well as an external structure such as wired and wireless networks have been diversified for each function. A user has selected a terminal and a network to be used according to a desired function and further, spectrums of a terminal and a network which an enterprise provides to the user have been diversified.

In this regard, in recent years, as a broadcast having a high definition (HD) resolution has been extended and serviced worldwide as well as domestically, a lot of users have been familiar with a high definition image. As a result, a lot of image service associated organizations have made a lot of efforts to develop a next-generation image apparatus.

Further, with an increase in interest in ultra high definition (UHD) having four times higher resolution than an HDTV as well as the HDTV, a requirement for technology that compresses and processes a higher resolution and higher definition image has been further increased.

In order to compress and process the image, inter prediction technology of predicting a pixel value included in a current image from a temporally prior and/or post image, intra prediction technology of predicting another pixel value included in the current image by using pixel information in the current image, and entropy encoding technology of allocating a short sign to a symbol in which an appearance frequency is high and a long sign to a symbol in which the appearance frequency is low, and the like may be used.

As described above, when respective terminals and networks having different supported functions, and the diversified user requirements are considered, a quality, a size, a frame, and the like of a supported image need to be consequently diversified.

As such, due to heterogeneous communication networks, and terminals having various functions and various types of terminals, scalability that variously supports the quality, resolution, size, frame rate, and the like of the image becomes a primary function of a video format.

Accordingly, it is necessary to provide a scalability function so as to achieve video encoding and decoding in terms of time, space, image quality, and the like in order to provide a service required by the user under various environments based on a high-efficiency video encoding method.

### DISCLOSURE

### Technical Problem

An object of the present invention is to provide an apparatus and an apparatus for image encoding/decoding that can improve encoding/decoding efficiency.

Another object of the present invention is to provide a method and an apparatus that perform inter-layer switching in scalable video coding that can improve encoding/decoding efficiency.

Yet another object of the present invention is to provide a method and an apparatus that provide information for indicating a point when inter-layer switching is achievable in scalable video coding.

### TECHNICAL SOLUTION

In accordance with an aspect of the present invention, there is provided a method for image decoding supporting a plurality of layers. The image decoding method supporting a plurality of layer includes the steps of receiving a bitstream including inter-layer switching point information representing whether inter-layer switching from a first layer to a second layer is possible; and decoding the bitstream based on the inter-layer switching point information. The inter-layer switching point information includes information on a layer switching picture (LSP) at a point when the inter-layer switching is possible, and the information on the layer switching picture is induced from a network abstraction layer (NAL) parsed from the bitstream.

In accordance with another aspect of the present invention, there is provided an apparatus for image decoding supporting a plurality of layers. The image decoding apparatus includes a decoding unit receiving a bitstream including inter-layer switching point information representing whether inter-layer switching from a first layer to a second layer is possible and decoding the bitstream based on the inter-layer switching point information. The inter-layer switching point information includes information on a layer switching picture (LSP) at a point when the inter-layer switching is possible, and the information on the layer switching picture is induced from a network abstraction layer (NAL) parsed from the bitstream.

In accordance with yet another aspect of the present invention, there is provided a method for image encoding supporting a plurality of layers. The image encoding method includes the steps of encoding inter-layer switching point information representing whether inter-layer switching from a first layer to a second layer is possible; and transmitting a bitstream including the inter-layer switching point information. The inter-layer switching point information includes information on a layer switching picture (LSP) at a point when the inter-layer switching is possible, and the information on the layer switching picture is specified as a network abstraction layer (NAL) unit type.

In accordance with still another aspect of the present invention, there is provided an apparatus for image encoding supporting a plurality of layers. The image encoding apparatus includes an encoding unit encoding inter-layer switching point information representing whether inter-layer switching from a first layer to a second layer is possible and transmitting a bitstream including the inter-layer switching point information. The inter-layer switching point information includes information on a layer switching picture (LSP) at a point when the inter-layer switching is possible, and the information on the layer switching picture is specified as a network abstraction layer (NAL) unit type.

### Advantageous Effects

When inter-layer switching is performed in scalable video coding, an indicator or an identifier that represents an image in which inter-layer switching is achievable can be allocated when the inter-layer switching is performed in the scalable video coding. Further, the inter-layer switching is achieved in the image in which the inter-layer switching is achievable by determining the indicator or identifier that represents the image in which the inter-layer switching is achievable, and as a result, normal transmission and decoding can be performed.

### DESCRIPTION OF DRAWINGS

FIG. 1 is a block diagram illustrating a configuration of an image encoding apparatus according to an embodiment of the present invention;

FIG. 2 is a block diagram illustrating a configuration of an image decoding apparatus according to an embodiment of the present invention;

FIG. 3 is a conceptual diagram schematically illustrating one example of a scalable video coding structure using a plurality of layers according to the present invention;

FIG. 4 is a diagram illustrating a layer structure for a coded image processed by a decoding apparatus;

FIG. 5 is a diagram illustrating inter-layer switching in the scalable video coding structure according to the present invention;

FIG. 6 is a diagram illustrated in order to describe one example of a method of encoding or decoding a switched image at a point when inter-layer switching is achievable by referring to another layer according to an embodiment of the present invention;

FIG. 7 is a diagram for describing a picture (LSP) for indicating the point when the inter-layer switching is achievable according to an embodiment of the present invention;

FIG. 8 is a diagram for describing a method of normally performing the inter-layer switching when the inter-layer switching occurs in the picture (LSP) for indicating the point when the inter-layer switching is achievable according to an embodiment of the present invention;

FIG. 9 is a flowchart schematically illustrating an encoding method of image information according to an embodiment of the present invention; and

FIG. 10 is a flowchart schematically illustrating a decoding method of image information according to an embodiment of the present invention.

### MODE FOR INVENTION

Hereinafter, embodiments of the present invention will be described in detail with reference to the accompanying drawings. In describing the embodiments of the present specification, when it is determined that the detailed description of the known art related to the present invention may obscure the gist of the present invention, the corresponding description thereof may be omitted.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Moreover, a content of describing “including” a specific component in the specification does not exclude a component other than the corresponding component and means that an additional component may be included in the embodiments of the present invention or the scope of the technical spirit of the present invention.

Terms such first, second, and the like may be used to describe various components, but the components are not limited by the terms. The above terms are used only to discriminate one component from the other component. For example, without departing from the scope of the present invention, a first component may be referred to as a second component, and similarly, a second component may be referred to as a first component.

Further, components described in the embodiments of the present invention are independently illustrated in order to show different characteristic functions and each component is not constituted by separated hardware or one software constituting unit. That is, each component includes respective components which are arranged for easy description and at least two components of the respective components may constitute one component or one component is divided into a plurality of components which may perform their functions. Even an integrated embodiment and separated embodiments of each component is also included in the scope of the present invention without departing from the spirit of the present invention.

Further, some components are not requisite components that perform essential functions but selective components for just improving performance in the present invention. The present invention may be implemented with the requisite component for implementing the spirit of the present invention other than the component used to just improve the performance and a structure including only the requisite component other than the selective component used to just improve the performance is also included in the scope of the present invention.

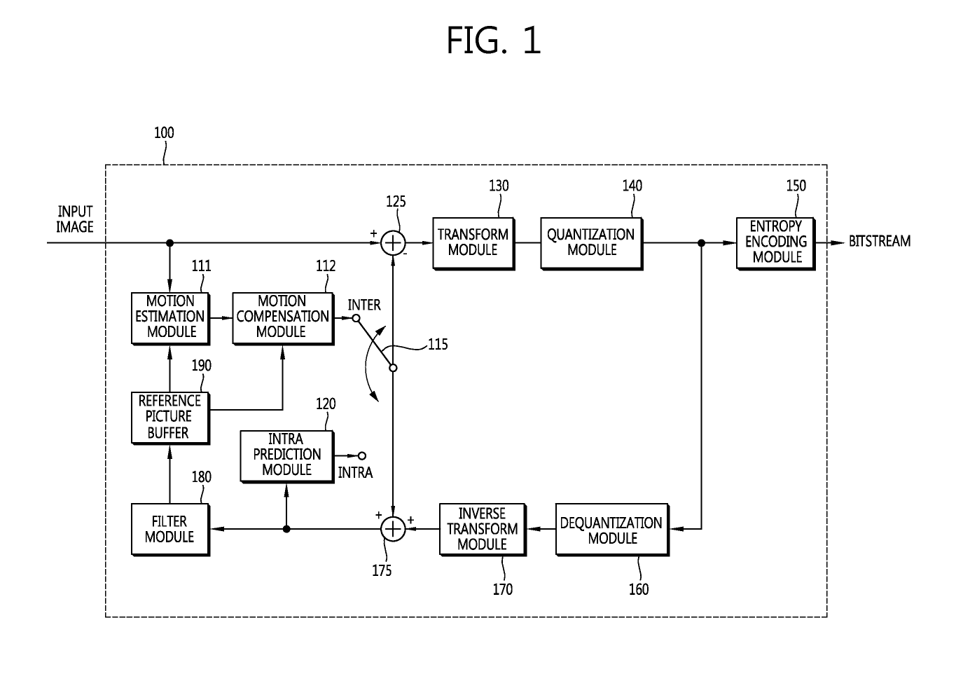

FIG. 1 is a block diagram illustrating a configuration of an image decoding apparatus according to an embodiment of the present invention.

A method or an apparatus for scalable video encoding/decoding may be implemented by extension of a general image encoding/decoding method or apparatus which does not provide scalability and the block diagram of FIG. 1 illustrates an embodiment of an image encoding apparatus which may be a base of the scalable video encoding apparatus.

Referring to FIG. 1, an image encoding apparatus 100 includes a motion estimation module 111, a motion compensation module 112, an intra prediction module 120, a switch 115, a subtractor 125, a transform module 130, a quantization module 140, an entropy encoding module 150, a dequantization module 160, an inverse transform module 170, an adder 175, a filter module 180, and a reference image buffer 190.

The image encoding apparatus 100 may encode an input image in an intra mode or an inter mode and output a bitstream. In the intra mode, the switch 115 may be switched to intra and in the inter mode, the switch 115 may be switched to inter. An intra prediction means an intra prediction and an inter prediction means an inter-screen prediction. The image encoding apparatus 100 may generate a prediction block for an input block of the input image and thereafter, encode a residual between the input block and the prediction block. In this case, the input image may mean an original image.

In the intra mode, the intra prediction module 120 may generate the prediction block by performing a spatial prediction by using a pixel value of an already encoded/decoded block adjacent to a current block.

In the inter mode, the motion estimation module 111 may acquire a motion vector by finding an area of a reference image stored in the reference image buffer 190 which most matches the input block during a motion prediction process. The motion compensation module 112 compensates for a motion by using the motion vector to generate the prediction block. Herein, the motion vector is a 2D vector used in the inter prediction and may represent an offset between a current encoding/decoding target image and a reference image.

The subtractor 125 may a residual block by a residual between the input block and the generated prediction block.

The transform module 130 performs transformation for the residual block to output a transform coefficient. Herein, the transform coefficient may mean a coefficient value generated by converting the residual block and/or a residual signal. Hereinafter, in this specification, the transform coefficient is quantized and a quantized transform coefficient level may also be called the transform coefficient.

The quantization module 140 quantizes an input transform coefficient according to a quantization parameter to output a quantized coefficient. The quantized coefficient may be called the quantized transform coefficient level. In this case, the quantization module 140 may quantize the input transform coefficient by using a quantization matrix.

The entropy encoding module 150 performs entropy encoding based on values calculated by the quantization module 140 or an encoded parameter value calculated during encoding to output the bitstream. When entropy encoding is applied, a small number of bits are allocated to a symbol having a high generation probability is allocated and a large number of bits are allocated to a symbol having a low generation probability to express the symbol, and as a result, the size of a bitstream for symbols to be encoded may be reduced. Therefore, compression performance of image encoding may be increased through the entropy encoding. The entropy encoding module 150 may use encoding methods such as exponential-Golomb, context-adaptive variable length coding (CAVLC), and context-adaptive binary arithmetic coding (CABAC) for the entropy encoding.

Since the image encoding apparatus 100 according to the embodiment of FIG. 1 performs inter prediction encoding, that is, inter-screen prediction encoding, a currently encoded image needs to be decoded and stored to be used as the reference image. Accordingly, the quantized coefficient is inversely quantized by the dequantization module 160 and inversely transformed by the inverse transform module 170. The inversely quantized and inversely transformed coefficient is added to the prediction block by the adder 175 and a reconstructed block is generated.

The reconstruction block passes through the filter module 180 and the filter module 180 may be apply at least one of a deblocking filter, a sample adaptive offset (SAO), and an adaptive loop filter (ALF) to the reconstruction block or a reconstruction image. The filter module 180 may be called an adaptive in-loop filter. The deblocking filter may remove block distortion which occurs on a boundary between blocks. The SAO may add an appropriate offset value to a pixel value in order to compensate for coding error. The ALF may perform filtering based on a value acquired by comparing the reconstructed image and the original image. The reconstruction block which passes through the filter module 180 may be stored in the reference image buffer 190.

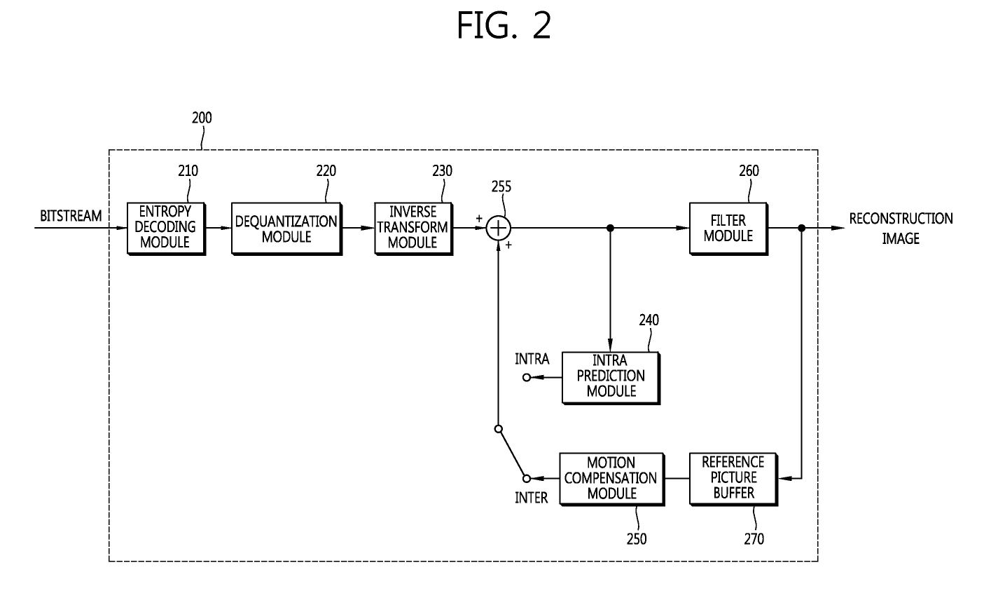

FIG. 2 is a block diagram illustrating a configuration of an image decoding apparatus according to an embodiment of the present invention.

As described in detail in FIG. 1, the method or apparatus for scalable video encoding/decoding may be implemented by the extension of the general image encoding/decoding method or apparatus which does not provide the scalability and the block diagram of FIG. 2 illustrates an embodiment of an image decoding apparatus which may be a base of the scalable video decoding apparatus.

Referring to FIG. 2, an image decoding apparatus 200 includes an entropy decoding module 210, a dequantization module 220, an inverse transform module 230, an intra prediction module 240, a motion compensation module 250, an adder 255, a filter module 260, and a reference picture buffer 270.

The image decoding apparatus 200 may receive a bitstream output by an encoder and decodes the received bitstream in the intra mode or the inter mode, and output the reconstructed image, that is, the reconstruction image. In the intra mode, a switch may be switched to intra and in the inter mode, the switch may be switched to inter.

The image decoding apparatus 200 may acquire a reconstructed residual block from the received bitstream and generate a block reconstructed by adding the reconstructed residual block and the prediction block after generating the prediction block, that is, the reconstruction block.

The entropy decoding apparatus 210 entropy-decodes the received bitstream according to a probability distribution to generate symbols including a symbol including a symbol of a quantized coefficient type.

When entropy decoding is applied, a small number of bits are allocated to a symbol having a high generation probability is allocated and a large number of bits are allocated to a symbol having a low generation probability to express the symbol, and as a result, the size of a bitstream for each symbol may be reduced.

A quantized coefficient is inversely quantized by the dequantization module 220 and inversely transformed by the inverse transform module 230, and the quantized coefficient is inversely quantized/inversely transformed, and as a result, the reconstructed residual block may be generated. In this case, the dequantization module 220 may apply a quantization matrix to the quantized coefficient.

In the intra mode, the intra prediction module 240 may generate the prediction block by performing a spatial prediction by using a pixel value of an already decoded block adjacent to a current block. In the inter mode, the motion compensation module 250 compensates for a motion by using a motion vector and a reference image stored in the reference picture buffer 270 to generate the prediction block.

The residual block and the prediction block are added through the adder 255 and the added blocks may pass through the filter module 260. The filter module 260 may apply at least one of the deblocking filter, the SAO, and the ALF to the reconstruction block or the reconstruction picture. The filter module 260 may output the reconstructed image, that is, the reconstruction image. The reconstruction image is stored in the reference picture buffer 270 to be used in the inter prediction.

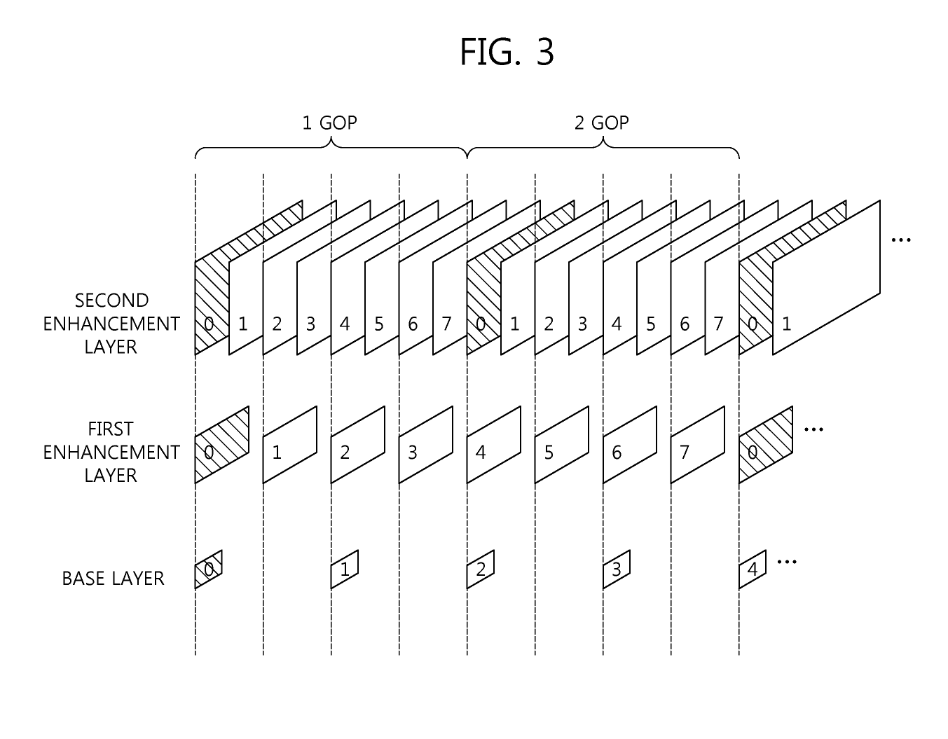

FIG. 3 is a conceptual diagram schematically illustrating one example of a scalable video coding structure using a plurality of layers according to the present invention. In FIG. 3, a group of image (GOP) represents a picture group, that is, a group of pictures.

A transmission medium is required to transmit image data and performance thereof is different for each transmission medium according to various network environments. The scalable video coding method may be provided to be applied to various transmission media or network environments.

The video coding method (hereinafter, referred to as ‘scalable coding’ or ‘scalable video coding’) supporting the scalability is a coding method that increases encoding and decoding performances by removing inter-layer redundancy by inter-layer texture information, motion information, a residual signal, and the like. The scalable video coding method may provide various scalabilities in spatial, temporal, and quality terms according to surrounding conditions such as transmission bit rate, transmission error rate, a system resource, and the like.

Scalable video coding may be performed by using a multiple-layer structure so as to provide a bitstream which is applicable to various network situations. For example, a scalable video coding structure may include a base layer that compresses and processes the image data by using the general image decoding method and may include an enhancement layer that compresses and processes the image data by using both decoding information of the base layer and the general decoding method.

Herein, a layer means a set of images and bitstreams that are distinguished based on a space (for example, an image size), a time (for example, a decoding order, an image output order, and frame rate), image quality, complexity, and the like. Further, the base layer may a basic layer, and the enhancement layer may mean an improvement layer or a higher layer. A layer that supports a lower scalability than a specific layer may be called a lower layer and a layer which the specific layer refers to in encoding or decoding may be called a reference layer.

Referring to FIG. 3, for example, the base layer may be defined by standard definition (SD), 15 Hz frame rate, and 1 Mbps bit rate, a first enhancement layer may be defined by high definition (HD), 30 Hz frame rate, and 3.9 Mbps bit rate, and a second enhancement layer may be defined by 4 K-ultra high definition (UHD), 60 Hz frame rate, and 27.2 Mbps.

The format, frame rate, bit rate, and the like as one embodiment may be decided differently as necessary. Further, the number of used layers is not limited to the embodiment and may be decided differently according to a situation. For example, if a transmission bandwidth is 4 Mbps, data may be transmitted at 15 Hz or less by decreasing the frame rate of the HD of the first enhancement layer.

The scalable video coding method may provide a temporal, spatial, image-qualitative scalability by the method described in detail in the embodiment of FIG. 3.

In this specification, the scalable video coding has the same as the scalable video encoding in terms of encoding and the scalable video decoding in terms of decoding.

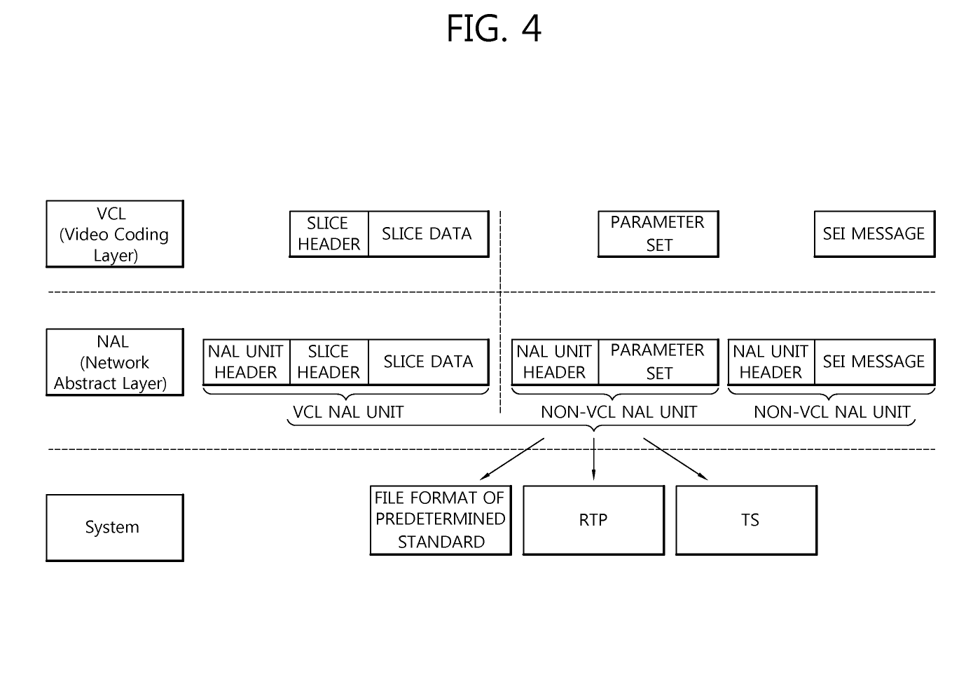

FIG. 4 is a diagram illustrating a layer structure for a coded image processed by a decoding apparatus.

A coded image is divided into decoding processing of an image and a video coding layer (VCL) handling the decoding processing, a lower system transmitting and storing encoded information, and a network abstraction layer (NAL) that exists between the VCL and the lower system and is in charge of a network adaptation function.

In the VCL, VCL data including compressed image data (slice data) is created, or a parameter set including information such as a picture parameter set (PPS), a sequence parameter set (SPS), a video parameter set (VPS), or the like, or a supplemental enhancement information (SEI) message additionally required during decoding the image may be created.

In the NAL, header information (NAL unit header) is added to a raw byte sequence payload created in the VCL to create an NAL unit. In this case, the RBSP represents the slice data created in the VCL, the parameter set, the SEI message, and the like. The NAL unit header may include NAL unit type information specified according to RBSP data included in a corresponding NAL unit.

As illustrated in FIG. 4, the NAL unit may be divided into the VCL NAL unit and a non-VCL NAL unit according to the RSSP created in the VCL. The VCL NAL unit means the NAL unit including information (slice data) on an image and the non-VCL NAL unit means the NAL unit including information (parameter set or SEI message) required to decode the image.

The VCL NAL unit and the non-VCL NAL unit are added to the header information according to a data standard of the lower system to be transmitted through the network. For example, the NAL unit is transformed to data types of a predetermined standard such as an H.264/AVC file format, a real-time transport protocol (RTP), a transport stream (TS), and the like to be transmitted through various networks.

Meanwhile, the scalable video coding structure, inter-layer switching may be performed according to a decoder or a transmission environment of the network. For example, in the scalable video coding structure, when a scalability for the resolution is supported, different resolutions may be provided for each layer and the resolution may be changed by switching a current layer to another layer.

The inter-layer switching (layer switching) represents switching the current layer to another layer and may be inter-layer switching of switching the lower layer to the higher layer or inter-layer switching of switching the higher layer to the lower layer. The inter-layer switching may be a switching point for a spatial layer or a quality layer.

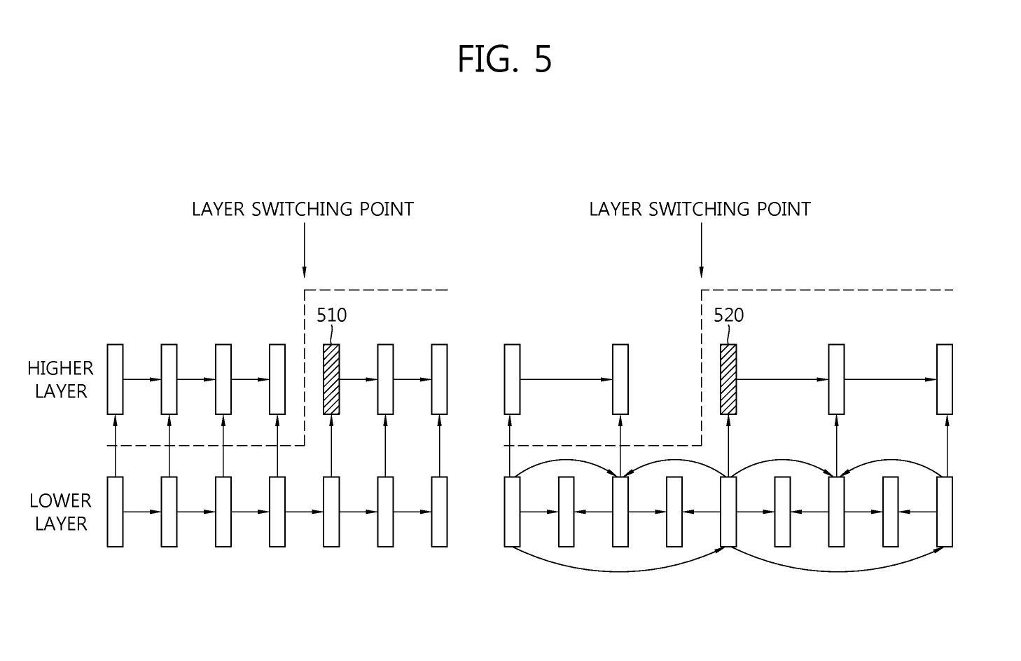

FIG. 5 is a diagram illustrating inter-layer switching in the scalable video coding structure according to the present invention.

The scalable video coding may provide the scalability in the spatial, temporal, and image-qualitative (or qualitative) terms as described above and may include a plurality of layer for the scalability.

In the embodiment of FIG. 5, a scalable video coding structure constituted by two layers is illustrated for easy description. The lower layer may be the base layer and the higher layer may be the enhancement layer. In this case, the layer may be a spatial scalable layer or a quality scalable layer.

For example, when the current layer (lower layer) in which encoding or decoding is performed at present is switched to another layer (higher layer), in the case where a picture at the switching in the switched layer (higher layer) is not a picture in which the intra prediction is performed, a problem may occur in the inter-layer switching. In other words, in the case where the picture at the switching in the switched layer (higher layer) is a picture in which the inter-screen prediction (inter prediction) is performed and a picture which is earlier than the picture at the switching in terms of a display order or an output order is referred to, encoding or decoding in the switched layer may not normally be performed. The reason is that since the picture which is earlier than the picture at the switching point in terms of the display order may not be present in a bitstream of the switched layer or a decoded picture buffer, the picture at the switching point may not refer to the picture which is earlier than the picture at the switching point.

As such, when the inter-layer switching of switching the current layer (lower layer) in which encoding or decoding is performed at present to another layer (higher layer) occurs, information on the point when the inter-layer switching is possible is provided in the embodiment of the present invention, so that encoding or decoding is normally performed in the switched layer (higher layer). As illustrated in FIG. 5, switching pictures 510 and 520 for indicating the point when the inter-layer switching is possible may be used in the embodiment of the present invention.

In the case of the switching pictures 510 and 520 for indicating the point when the inter-layer switching is possible, picture which are earlier than the switching pictures 510 and 520 in the display order among pictures which are positioned on the same layer (higher layer) as the switching pictures 510 and 520 are not used as the reference picture. On the contrary, the switching pictures 510 and 520 may refer to pictures on another layer (lower layer). For example, the switching pictures 510 and 520 may refer to a block of a lower layer at a location corresponding to an encoding or decoding target block in the switching pictures 510 and 520 or refer to a block of a lower layer acquired through a motion prediction for the encoding or decoding target block in the switching pictures 510 and 520.

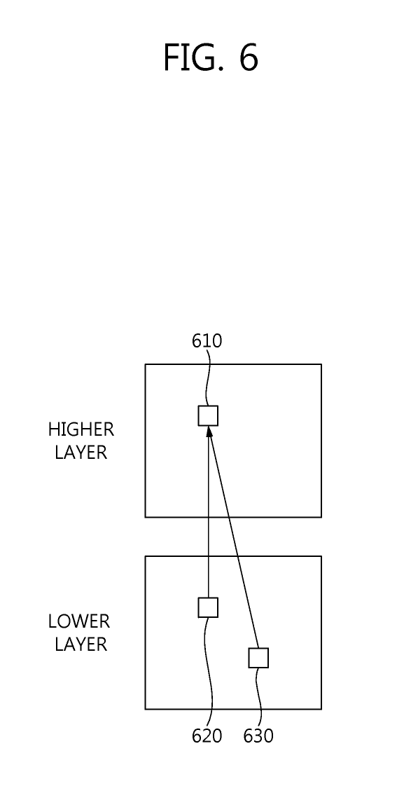

FIG. 6 is a diagram illustrated in order to describe one example of a method of encoding or decoding a switched picture at a point when inter-layer switching is achievable by referring to another layer according to an embodiment of the present invention.

Referring to FIG. 6, when the inter-layer switching from the lower layer to the higher layer occurs, an encoding or decoding target block (hereinafter, referred to as a ‘target block’) 610 of the higher layer may perform encoding or decoding by referring the lower layer. Since the lower layer is a layer which the target block 610 refers to, the lower layer may be called the reference layer.

For example, the target block 610 of the switching picture may perform a prediction by using a corresponding block (co-located block) 620 of the lower layer corresponding to the target block 610 as the reference block. Alternatively, the prediction may be performed by using a predetermined block 630 which is positioned at a location other than the corresponding block 620 of the lower layer as the reference block. In this case, the predetermined block 630 may be a block in the lower layer which is induced based on a motion vector acquired through the motion prediction for the target block 610.

As described above, in order to perform normal encoding or decoding when the inter-layer switching occurs, the switching picture for indicating the point when the inter-layer switching is possible may be used according to the embodiment of the present invention. The switching picture may be known through an indicator or an identifier for representing the switching picture. In the embodiment of the present invention, as the indicator or identifier for representing the switching picture, an NAL unit type may be used. That is, the NAL unit type for the switching picture may be defined. For example, the NAL unit type for the switching picture may be used as the layer switching picture (LSP). If the NAL unit type is the LSP, the inter-layer switching from the lower layer to the higher layer or from the higher layer to the lower layer may be performed in the LSP. Further, a flag representing the switching picture as the indicator may be transmitted.

Meanwhile, a temporal sub-layer switching access (TSA) or step-wise temporal sub-layer switching access (STSA) picture may be used for temporal layer switching. In this case, locations of the TSA or STSA pictures of the higher layer and the lower layer may coincide with each other. In other words, when the higher layer is the TSA or STSA picture, the lower layer may also be the TSA or STSA picture.

In the embodiment of the present invention, inter-layer switching acquired by combining the temporal layer switching and layer switching of the spatial layer or the quality according to the present invention may be performed. For example, a layer supporting the SD 15 Hz frame rate may be switched to a layer supporting the HD 30 Hz frame rate and in this case, the TSA or STSA picture may be accompanied next to the LSP.

As descried above, the NAL unit type may be specified according to data included in the NAL unit, for example, a picture included in the NAL unit and information on the NAL unit type may be stored in the NAL unit header.

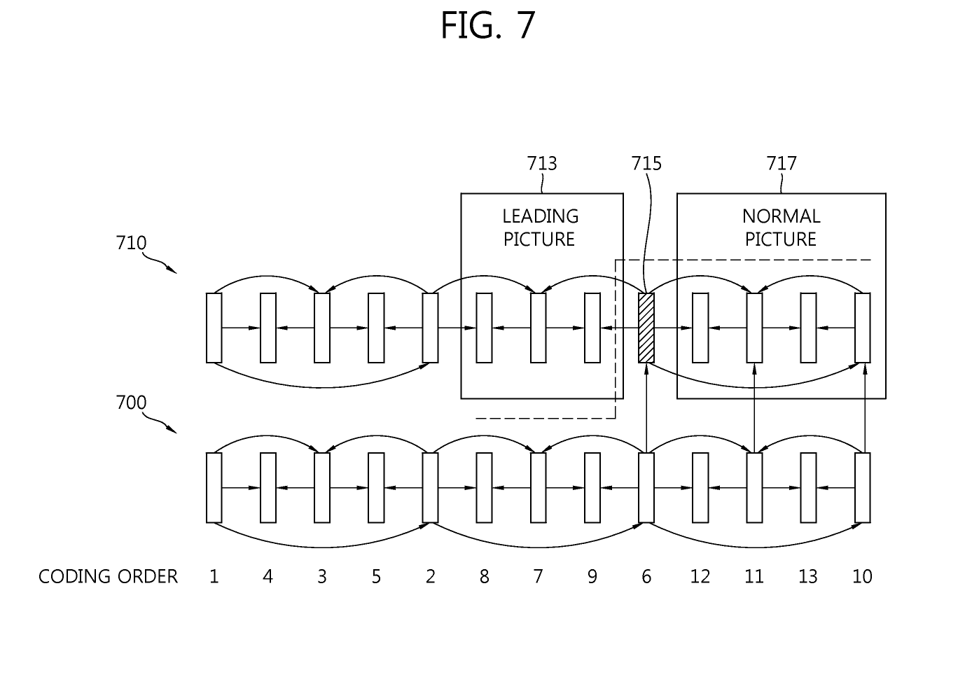

FIG. 7 is a diagram for describing a picture (LSP) for indicating the point when the inter-layer switching is achievable according to an embodiment of the present invention.

In the embodiment of FIG. 7, the scalable video coding structure constituted by two layers is illustrated for easy description. The lower layer 700 may be the base layer and the higher layer 710 may be the enhancement layer. In this case, the layer may be the spatial scalable layer or the quality scalable layer.

A coding order of the picture is illustrated in FIG. 7 and the coding order may be an encoding order or a decoding order. A display order or an output order of the picture may be decided sequentially from a picture illustrated at a left side to a picture illustrated at a right side. As illustrated in the figure, the coding order and the display order of the picture may be different from each other. An arrow illustrated in FIG. 7 represents a reference relationship regarding whether the picture refers to another picture. For example, a picture of which a coding order of the higher layer 710 is 6 uses a picture of which a coding order of lower layer is 6 as the reference picture and the picture of which the coding order of the higher layer 710 is 6 is used as the reference picture of pictures of which coding orders 7, 9, 10, 11, and 12 of the higher layer 710.

In the scalable video coding illustrated in FIG. 7, a layer that receives an image may be changed according to the decoder or the network transmission environment. For example, the decoder may perform decoding by receiving the image through only the lower layer 700 according to the network transmission environment and may perform decoding by receiving the image through the higher layer 710 together with the lower layer 700 by switching the layer from the lower layer 700 to the higher layer 710. In this case, encoding or decoding may not normally be performed when the layer switching is achieved due to the reference relationship in encoding or decoding as described above.

In order to solve the problem, the present invention proposes the NAL unit type for notifying the point when the inter-layer switching is possible in the scalable coding structure supporting the spatial or qualitative. The NAL unit type according to the embodiment of the present invention may be the layer switching picture (LSP). The LSP (layer switching picture) may be a picture at the point when the inter-layer switching is possible.

The LSP 715 according to the embodiment of the present invention and pictures decoded after the LSP 715 may have a condition below in order to perform the normal encoding or decoding when the inter-layer switching is performed.

The LSP 715 is a slice in which the intra prediction mode and the inter-layer prediction mode are possible.

In this case, the intra prediction mode represents performing the prediction by using an already encoded or decoded block which is positioned around a current encoding or decoding target block and the inter-layer prediction mode represents performing the prediction for the current encoding or decoding target block by using information on another layer.

When the prediction mode of the LSP 715 is the inter-layer prediction mode, the LSP 715 may perform the prediction by referring to the picture (or block) at a location corresponding (co-located) to the LSP 715 in another layer (for example, the lower layer 700) or create the prediction signal by referring to a picture (or block) of another layer (for example, the lower layer 700) at a location other than the picture (or block) at the location corresponding (co-located) to the LSP 715. For example, it is possible to refer to the picture (or block) of another layer (for example, the lower layer 700) acquired through the motion prediction for the LSP 715.

A leading picture 713 which is earlier than the LSP 715 in the display order, but is later than the LSP 715 in the coding (encoding/decoding) order may refer to the LSP 715. In other words, the LSP 715 may be used as the reference picture of the leading picture 713.

A normal picture 717 which is later than the LSP 715 in the display order and the coding (encoding/decoding) order may not refer to pictures output (displayed) prior to the LSP 715. In other words, the normal picture 717 may refer to the LSP 715, but may not refer to the pictures (including the leading picture) which are earlier than the LSP 715 in the display order.

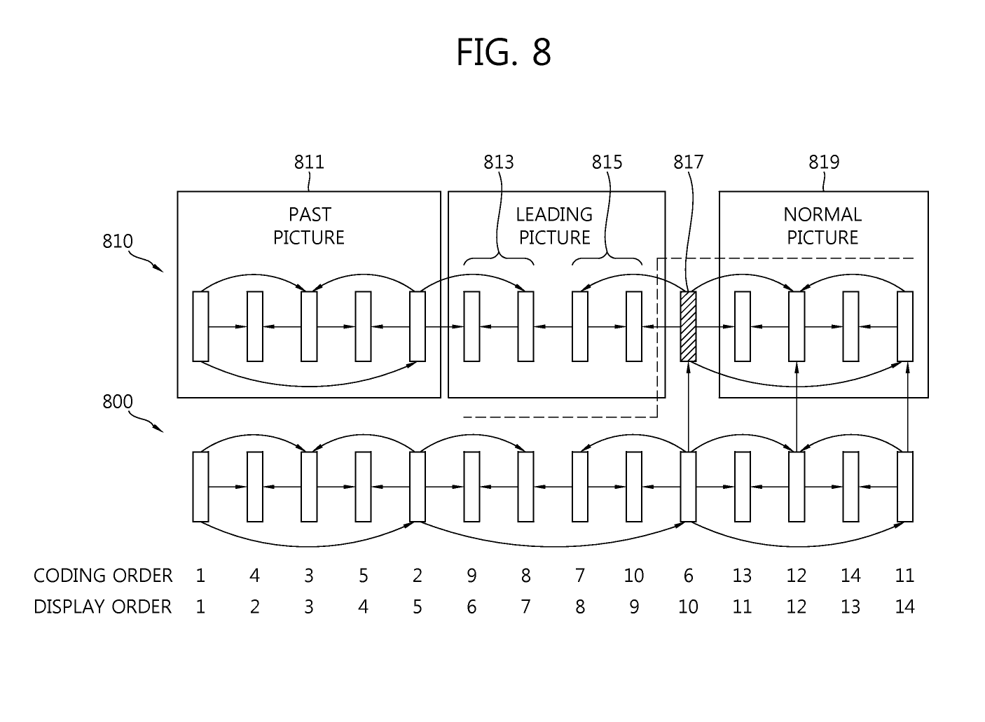

FIG. 8 is a diagram for describing a method of normally performing the interlayer switching when the interlayer switching occurs in the picture (LSP) for indicating the point when the interlayer switching is achievable according to an embodiment of the present invention.

In the embodiment of FIG. 8, the scalable video coding structure constituted by two layers is illustrated for easy description. The lower layer 800 may be the base layer and the higher layer 810 may be the enhancement layer. In this case, the layer may be the spatial scalable layer or the quality scalable layer.

The coding order and the display order (or output order) are illustrated in FIG. 8. The coding order may be the encoding or the decoding order. As illustrated in the figure, the coding order and the display order of the picture may be different from each other. An arrow illustrated in FIG. 8 represents a reference relationship regarding whether the picture refers to another picture.

For example, when the inter-layer switching actually occurs in an LSP 817 at the point when the inter-layer switching is possible, it is necessary to notify that the inter-layer switching occurs in the LSP 817 in order to normally encode or decode the LSP 817 and pictures encoded or decoded after the LSP 817. In this case, the LSP may be a clean random access (CRA) picture.

As one example, a type of the LSP 817 may be changed in order to notify that the inter-layer switching occurs in the LSP 817. For example, the LSP may be changed to a type such as a broken link access (BLA) picture. The NAL unit type is changed from the LSP to the BLA, and as a result, it may be recognized that the inter-layer switching actually occurs in the LSP 817.

Herein, the BLA picture is a picture for indicating a location in a bitstream which is operable as a random access point when the bitstream is spliced or cut in the middle. The BLA picture may be decided from an encoding device or the LSP may be changed to the BLA picture in a system receiving the bitstream from the encoding device. For example, when the bitstream is actually inter-switched in the LSP, a system (for example, a system level such as an extractor or a middle box) changes the LSP to the BLA picture to provide the changed BLA picture to a decoding device that decodes the image. In this case, parameter information for the image may be newly provided to the decoding device. In the present invention, the decoding device means a device that is capable of decoding the image and may be implemented by the decoding device of FIG. 2 or a core module that decodes the image.

If the NAL unit type is changed from the LSP to the BLA in the LSP 817, the LSP 817 and a normal picture 819 which is later than the LSP 817 in the display order or the coding order may be encoded or decoded by referring to another layer (lower layer 800) as described above. In this case, the normal picture 819 may refer to the

LSP 817 or another normal picture, but may not refer to pictures (for example, 811, 813, and 815) which are output prior to the LSP 817.

Meanwhile, the leading pictures 813 and 815 which are earlier than the LSP 817 in the display order and later than the LSP 817 in the coding order may be encoded or decoded by referring to another leading picture or a past picture 811 which is earlier than the leading pictures 813 and 815 in the display order and the coding order. In this case, when the inter-layer switching occurs in the LSP 817, the past picture 811 is not present in the received bitstream or the decoded picture buffer (DPB), and as a result, the past picture 811 may not be available. Accordingly, the leading picture 813 which refers to the past picture 811 in the leading pictures 813 and 815 may not be reconstructed while decoding. In this case, the leading picture 813 which is impossible to normally decode by referring to the picture which is not available may be not decoded but skipped during the decoding. In other words, the leading picture 813 which is impossible to decode may be removed and wasted from the bitstream.

When the inter-layer switching occurs according to the embodiment of the present invention, the leading picture which is possible to decode in the leading pictures 813 and 815 may be decoded by referring to the LSP 817 or another leading picture (another leading picture which is impossible to decode), and the leading picture which is not normally decoded but skipped is removed from the bitstream to be excluded during the decoding or outputting. Alternatively, both the leading picture 815 which is possible to decode and the leading picture 813 which is impossible to decode are removed from the bitstream and thereafter, may be decoded.

Further, when the inter-layer switching occurs in the LSP 817, a sequence parameter set (SPS) of a corresponding layer may be activated in the LSP 817. As another example, when the inter-layer switching actually occurs in the LSP 817 at the point when the inter-layer switching is possible, the decoding device may recognize that the inter-layer switching occurs in the LSP 817 through the NAL unit which is input. For example, the decoding device may determine whether the inter-layer switching occurs through layer identifier information for identifying the layer stored in the NAL unit header. In this case when the inter-layer switching occurs in the LSP 817, the SPS of the corresponding layer may be activated in the LSP 817.

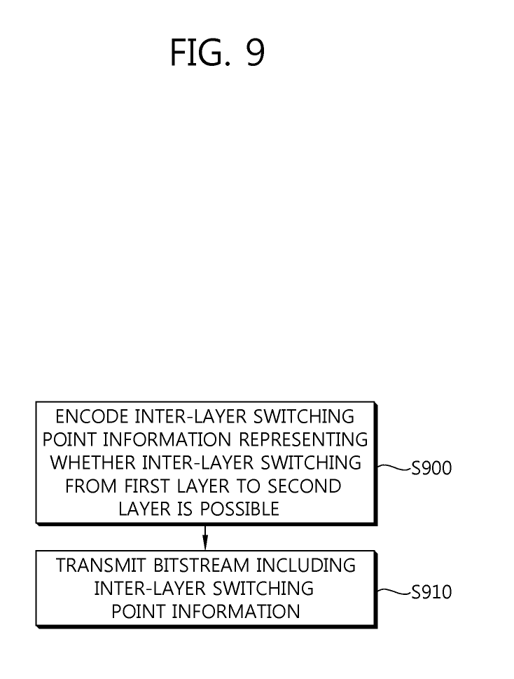

FIG. 9 is a flowchart schematically illustrating an encoding method of image information according to an embodiment of the present invention. The method of FIG. 9 may be performed by the encoding device of FIG. 1.

Referring to FIG. 9, the encoding device encodes inter-layer switching point information representing whether inter-layer switching from a first layer to a second layer is possible (S900). Herein, the inter-layer switching from the first layer to the second layer may be inter-layer switching from a lower layer to a higher layer or from the higher layer to the lower layer.

The inter-layer point information may include information on a layer switching picture (LSP) at the point when the inter-layer switching is possible. The information on the LSP may be specified as an NAL unit type. For example, the encoding device may store the NAL unit type for the LSP in an NAL unit header and thereafter, transmit the stored NAL unit type to the decoding device. That is, the encoding device encodes the NAL unit type as a nal_unit_type syntax to store the nal_unit_type syntax in the NAL unit header.

The encoding device does not use an earlier picture which is earlier than the LSP in a display order in pictures of the same layer (second layer) as the LSP when encoding the LSP. On the contrary, the encoding device may perform encoding by referring to a picture of a layer (first layer) other than the LSP.

When the LSP is encoded by referring to the picture of another layer, that is, when the LSP is encoded through the inter-layer prediction mode, the encoding target block in the LSP may be encoded by referring to the corresponding (co-located) block of another layer at the location corresponding to the encoding target block or the block of another layer acquired through the motion prediction for the encoding target block as described above.

Further, the encoding device may use the intra prediction method of creating the prediction signal by referring to the already encoded block positioned around the encoding target block in the LSP when encoding the LSP.

The encoding device may use the LSP as the reference picture when encoding the leading picture which is earlier than the LSP in the display order and later than the LSP in the encoding order. The leading picture may include a first leading picture which is not normally decoded but skipped and a second leading picture which is normally decodable, as described above. The encoding device specifies the first leading picture and the second leading picture as the NAL unit type for the leading picture to signal the pictures to the decoding device so as for the decoding device to know the first leading picture and the second leading picture.

The encoding device may use the LSP or another normal picture as the reference picture when encoding the normal picture which is later than the LSP in the display order and the encoding order, but does not use the picture which is earlier than the LSP in the display order as the reference picture.

The encoding device creates a bitstream including encoded information and transmits the created bitstream (S910). In this case, the encoded information may include the inter-layer switching point information, that is, the NAL unit type information for the LSP at the point when the inter-layer switching is possible. Further, when the leading picture is present, the encoded information may further include the NAL unit type information for the leading picture.

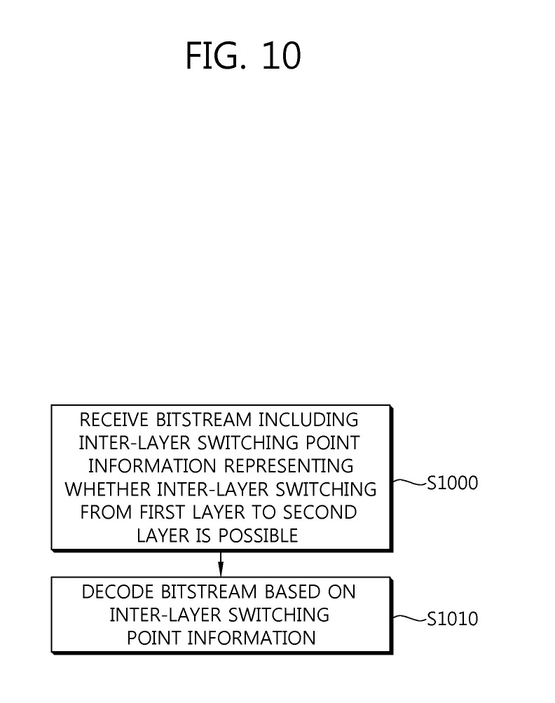

FIG. 10 is a flowchart schematically illustrating a decoding method of image information according to an embodiment of the present invention. The method of FIG. 10 may be performed by the decoding device of FIG. 2.

Referring to FIG. 10, the decoding device receives the inter-layer switching point information representing whether the inter-layer switching from the first layer to the second layer is possible (S1000). Herein, the inter-layer switching from the first layer to the second layer may be inter-layer switching from a lower layer to a higher layer or from the higher layer to the lower layer.

The inter-layer point information may include information on a layer switching picture (LSP) at the point when the inter-layer switching is possible. The information on the LSP may be specified as an NAL unit type. Accordingly, the decoding device acquires the information on the NAL unit type by parsing the received bitstream and may induce the information on the LSP through the acquired NAL unit type. For example, the decoding device may acquire the nal_unit_type syntax stored in the NAL unit header and know which NAL unit type the acquired NAL unit type through the nal_unit_type syntax.

The decoding device decodes the bitstream based on the inter-layer switching point information (S1010).

In this case, when the inter-layer switching from the first layer to the second layer occurs, the decoding device may decode the LSP at the point when the inter-layer switching in the bitstream is performed. The LSP does not use an earlier picture which is earlier than the LSP in the display order in pictures of the same layer (second layer) as the reference picture. On the contrary, the LSP may be decoded by referring to a picture of a layer (first layer) other than the LSP.

When the LSP is decoded by referring to the picture of another layer, that is, when the LSP is decoded through the inter-layer prediction mode, the decoding target block in the LSP may be decoded by referring to the corresponding (co-located) block of another layer at the location corresponding to the decoding target block or the block of another layer acquired through the motion prediction for the decoding target block as described above.

Further, the decoding device may use the intra prediction method of creating the prediction signal by referring to the already decoded block positioned around the decoding target block in the LSP when decoding the LSP.

The decoding device may use the LSP as the reference picture which is earlier than the LSP in the display order and later than the LSP in the decoding order when the inter-layer switching from the first layer to the second layer occurs and does not use a picture which is earlier than the LSP as the reference picture for the normal picture which is later than the LSP in the display order and the decoding order.

Meanwhile, when the NAL unit type for the LSP is changed for the LSP in the received bitstream, for example, when the NAL unit type is changed from the layer switching picture (LSP) to the broken link access (BLA) in the LSP, the decoding device may recognize that the inter-layer switching occurs from the first layer to the second layer.

The BLA picture is the picture for indicating the location in the bitstream which is operable as the random access point when the bitstream is spliced or cut in the middle, as described above. The BLA picture may be decided from the encoding device or the LSP may be changed to the BLA picture in the system receiving the bitstream from the encoding device when the random access or the inter-layer switching occurs.

Alternatively, the decoding device may recognize that the inter-layer switching from the first layer to the second layer occurs through the layer identifier information for identifying the layer parsed from the received bitstream. The layer identifier information may be induced from a nuh_layer_id syntax stored in the NAL unit header parsed from the bitstream.

When the decoding device recognizes that the inter-layer switching from the first layer to the second layer occurs in the LSP, the decoding device excludes the leading picture which is present in the bitstream during the decoding and outputting to decode the bitstream.

As described above, when the leading picture using the past picture which is earlier than the leading picture in the display order and the decoding order as the reference picture, it is impossible to normally decode the leading picture. The reason is that since the past picture is not present in the bitstream or DPB, the leading picture becomes an unavailable reference picture. That is, the leading picture may include the first leading picture which is not normally decoded but skipped and the second leading picture which is normally decodable, as described above. The information on the leading picture may be induced from the NAL unit type. For example, the decoding device may know the first leading picture and the second leading picture through the NAL unit type for the leading picture.

When the NAL unit type indicates the first leading picture, the decoding device may decode the bitstream by removing the first leading picture from the bitstream. Alternatively, when the NAL unit type indicates the second leading picture, the second leading picture is the picture which is normally decodable, and as a result, the decoding device may decode the second leading picture. Alternatively, the decoding device may exclude both the first leading picture and the second leading picture during the decoding and outputting.

In addition, when the inter-layer switching from the first layer to the second layer occurs in the LSP, the sequence parameter set of the corresponding layer may be activated in the LSP.

Although the inter-layer switching from the lower layer to the higher layer has been described for easy description in the embodiments of the present invention, the embodiments may be applied to even the inter-layer switching from the higher layer to the lower layer.

In the aforementioned embodiments, methods have been described based on flowcharts as a series of steps or blocks, but the methods are not limited to the order of the steps of the present invention and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present invention and may be deleted.

It will be appreciated that various embodiments of the present invention have been described herein for purposes of illustration, and that various modifications, changes, substitutions may be made by those skilled in the art without departing from the scope and spirit of the present invention. Accordingly, the various embodiments disclosed herein are not intended to limit the technical spirit but describe with the true scope and spirit being indicated by the following claims. The scope of the present invention may be interpreted by the appended claims and the technical spirit in the equivalent range are intended to be embraced by the invention.

1. A method for image decoding supporting a plurality of layers, the method comprising the steps of:
receiving a bitstream including inter-layer switching point information representing whether inter-layer switching from a first layer to a second layer is possible; and
decoding the bitstream based on the inter-layer switching point information,
wherein the inter-layer switching point information includes information on a layer switching picture (LSP) at a point when the inter-layer switching is possible, and the information on the layer switching picture is induced from a network abstraction layer (NAL) parsed from the bitstream.

2. The method of claim 1, wherein:
in the step of decoding the bitstream, when the inter-layer switching from the first layer to the second layer occurs,
the layer switching picture included in the bitstream does not use an earlier picture which is earlier than the LSP in a display order among pictures of the second layer as a reference picture.

3. The method of claim 1, wherein:
in the step of decoding the bitstream, when the inter-layer switching from the first layer to the second layer occurs,
the LSP included in the bitstream uses a picture of the first layer as the reference picture.

4. The method of claim 3, wherein a decoding target block in the LSP is decoded by referring to a corresponding (co-located) block of the first layer at a location corresponding to the decoding target block or a block of the first layer acquired through a motion prediction for the decoding target block.

5. The method of claim 1, wherein:
in the step of decoding the bitstream, when the inter-layer switching from the first layer to the second layer occurs,
the LSP included in the bitstream is decoded by using a prediction signal induced through an intra prediction or an inter-layer prediction.

6. The method of claim 5, wherein the inter-layer prediction for the decoding target block in the LSP induces a prediction signal by referring to the corresponding (co-located) block of the first layer at a location corresponding to the decoding target block or the block of the first layer acquired through the motion prediction for the decoding target block.

7. The method of claim 1, wherein:
in the step of decoding the bitstream, when the inter-layer switching from the first layer to the second layer occurs,
a leading picture which is earlier than the LSP in the display order and later than the LSP in a decoding order uses the LSP as the reference picture.

8. The method of claim 1, wherein:
in the step of decoding the bitstream, when the inter-layer switching from the first layer to the second layer occurs,
a normal picture which is later than the LSP in the display order and the decoding order does not use a picture which is earlier than the LSP in the display order as the reference picture.

9. The method of claim 1, wherein:
the step of decoding the bitstream includes a step of recognizing that the inter-layer switching from the first layer to the second layer occurs when the NAL unit type is changed from the LSP to a broken link access (BLA) picture, and
the BLA picture is a picture for indicating a location in the bitstream which is operable as a random access point when the bitstream is spliced or cut in the middle.

10. The method of claim 9, wherein the step of decoding the bitstream includes a step of removing the leading picture which is earlier than the BLA picture in the display order and later than the BLA picture in the decoding order from the bitstream when it is recognized that the inter-layer switching from the first layer to the second layer occurs.

11. The method of claim 10, wherein:
the leading picture includes a first leading picture which is not normally decoded but skipped and a second leading picture which is normally decoded, and
in the step of removing the leading picture from the bitstream,
the first leading picture is excluded during the decoding or outputting or the first leading picture and the second leading picture are excluded during the decoding and outputting.

12. The method of claim 1, wherein:
the step of decoding the bitstream includes a step of recognizing that the inter-layer switching from the first layer to the second layer occurs based on layer identifier information for identifying a layer parsed from the bitstream, and
the layer identifier information is included in an NAL unit header.

13. The method of claim 1, wherein:
in the step of decoding the bitstream, when the inter-layer switching from the first layer to the second layer occurs,
a sequence parameter set (SPS) of the second layer is activated.

14. An apparatus for image decoding supporting a plurality of layers, the apparatus comprising:
a decoding unit receiving a bitstream including inter-layer switching point information representing whether inter-layer switching from a first layer to a second layer is possible and decoding the bitstream based on the inter-layer switching point information,
wherein the inter-layer switching point information includes information on a layer switching picture (LSP) at a point when the inter-layer switching is possible, and the information on the layer switching picture is induced from a network abstraction layer (NAL) parsed from the bitstream.

15. A method for image encoding supporting a plurality of layers, the method comprising the steps of:
encoding inter-layer switching point information representing whether inter-layer switching from a first layer to a second layer is possible; and
transmitting a bitstream including the inter-layer switching point information,
wherein the inter-layer switching point information includes information on a layer switching picture (LSP) at a point when the inter-layer switching is possible, and
the information on the layer switching picture is specified as a network abstraction layer (NAL) unit type.

16. The method of claim 15, wherein:
in the step of encoding the inter-layer switching point information,
the layer switching picture does not use an earlier picture which is earlier than the LSP in a display order among pictures of the second layer as a reference picture but is encoded.

17. The method of claim 15, wherein:
in the step of encoding the inter-layer switching point information,
the LSP is encoded by using a picture of the first layer as the reference picture.

18. The method of claim 17, wherein an encoding target block in the LSP is encoded by referring to a corresponding (co-located) block of the first layer at a location corresponding to the encoding target block or a block of the first layer acquired through a motion prediction for the encoding target block.

19. The method of claim 15, wherein:
in the step of encoding the inter-layer switching point information,
the LSP included in the bitstream is encoded by using a prediction signal induced through an intra prediction or an inter-layer prediction.

20. The method of claim 19, wherein the inter-layer prediction for the encoding target block in the LSP induces a prediction signal by referring to the corresponding (co-located) block of the first layer at a location corresponding to the encoding target block or the block of the first layer acquired through the motion prediction for the encoding target block.

21. The method of claim 15, wherein:
in the step of encoding the inter-layer switching point information,
a leading picture which is earlier than the LSP in the display order and later than the LSP in an encoding order is encoded by using the LSP as the reference picture.

22. The method of claim 15, wherein:
in the step of encoding the inter-layer switching point information,
a normal picture which is later than the LSP in the display order and the encoding order does not use a picture which is earlier than the LSP in the display order as the reference picture but is encoded.

23. The method of claim 15, further comprising:
encoding information on the leading picture which is earlier than the LSP in the display order and later than the LSP in the encoding order,
the leading picture is specified as a network abstraction layer (NAL) unit type, and
the leading picture includes a first leading picture which is not normally decoded but skipped and a second leading picture which is normally decoded.

24. An apparatus for image encoding supporting a plurality of layers, the apparatus comprising:
an encoding unit encoding inter-layer switching point information representing whether inter-layer switching from a first layer to a second layer is possible and transmitting a bitstream including the inter-layer switching point information,
wherein the inter-layer switching point information includes information on a layer switching picture (LSP) at a point when the inter-layer switching is possible, and
the information on the layer switching picture is specified as a network abstraction layer (NAL) unit type.
